(19) United States
(12) Patent Application Publication
(10) Pub. No.: US 2006/0234620 A1
(43) Pub. Date: Oct. 19, 2006

(54) Transport vehicle for transporting chickens and method for ventilating a compartment thereof

(76) Inventor: Adrianus Henricus Maria Mennen, Vlierden (NL)

Correspondence Address: LAW OFFICES OF ERIC KARICH, 2807 ST. MARK DR., MANSFIELD, TX, 76063, US

(21) Appl. No.: 11/107,310

(22) Filed: Apr. 15, 2005

(51) Int. Cl. B60H 1/00

(52) U.S. Cl. 454/118

(57) ABSTRACT

A transport vehicle for transporting animals such as chickens has a compartment and a cab which is situated in front of and at a distance from the compartment. There are ventilating fans in the compartment's front wall which blow air from inside the compartment to the outside. By extracting air from the compartment at the front instead of blowing air into the compartment at the front, better ventilation is obtained. In the compartment's rear wall are air vents for taking in fresh air. There is a sponge made of plastic wire in front of the air vents for creating resistance to the air flowing in. Because of this, an under-pressure is created in the compartment near the air vents, assuring that air will flow in through all air vents and that the situation will be averted in which air will flow in only at one place, that where the least resistance is offered.

### CROSS-REFERENCE TO RELATED APPLICATIONS

Not Applicable

### BACKGROUND OF THE INVENTION

1. Field of the Invention

This invention relates generally to vehicles, and more particularly to a transport vehicle for transporting animals such as chickens, and a method for ventilating a compartment thereof.

2. Description of Related Art

A similar transport vehicle is disclosed in WO 03/031224 A1, which is hereby incorporated by reference in full. It has been found that during cold weather, however, that the temperature in the rear of the compartment gets too low for the animals to survive transportation, and a lot of the animals in the rear of the compartment die.

### SUMMARY OF THE INVENTION

The invention relates to a transport vehicle for transporting animals such as chickens, comprising a compartment with, as viewed in the direction of travel, a front wall and a rear wall, as well as a roof, a floor and two side walls, which transport vehicle, furthermore, comprises at least one ventilating fan, situated in or near an opening in the front wall, as well as at least one air vent in one of the compartment's walls, for taking in air, the ventilating fan is set up in such a way that it extracts air from the compartment.

The front in this situation is the upstream side with respect to the flow of air during transport. By a ventilating fan situated in or near an opening in the front wall is also meant a ventilating fan situated on the front wall and connected to the space in the compartment by means of an opening in the wall.

An objective of the invention is to provide a transport vehicle of the type described in the preamble in which ventilation of the compartment is improved. To this end, the transport vehicle according to the invention is characterized in that the transport vehicle comprises at least one further ventilating fan, situated in or near an opening in the rear wall of the compartment. Instead of exhausting air only through openings in the front wall, whereby the air is taken in through openings in the rear wall of the compartment, the air is alternately exhausted through openings in the front and rear wall whereby the air is alternately taken in through openings in the opposite wall. The air vents in the front and rear walls can be formed by the ventilating fans. Because of this the temperature in the compartment and especially in the rear of the compartment will be less low than in case air is only exhausted through openings in the front wall of the compartment.

During circumstances when temperature is not low the air is only exhausted by the ventilating fan in the front wall of the compartment. In that case the openings in the rear wall wherein the further ventilating fans are present can be closed and the air is taken in through other adjustable venting openings in the rear wall.

An embodiment of the transport vehicle according to the invention is characterized in that the ventilating fan is further set up in such a way that it exhausts the air to outside the transport vehicle in a direction at least substantially parallel to the direction of travel. Instead of exhausting air in a direction perpendicular to the direction of travel the air is exhausted in or at least substantially in the direction of travel. It has been found that in front of the compartment there is an area where the air pressure just outside the compartment is lower than it is inside. This under-pressure has a suction effect on the air in the compartment. Extracting the air from the compartment at this place with a ventilating fan is supported by this natural suction as a result of which better ventilation is achieved or smaller ventilating fans can be used.

A further embodiment of the transport vehicle according to the invention is characterized in that the transport vehicle comprises a cab which, as viewed in the direction of travel, is situated in front of as well as at a distance from the compartment, and the ventilating fan is situated behind the cab. There is an under-pressure between the cab and the compartment during transport when using transport vehicles with a cab in front. That is why it is advantageous to place the ventilating fan behind the cab.

Still a further embodiment is characterized in that there are a number of floors in the compartment and in addition to the ventilating fan mentioned, the transport vehicle comprises a number of additional ventilating fans which are distributed vertically in the front wall, and in addition to the further ventilating fan mentioned, a number of additional further ventilating fans, which are distributed vertically in the rear wall and which transport vehicle in addition to the air vent mentioned, comprises a number of additional air vents which are distributed vertically in the rear wall adjacent the further ventilating fans. In this embodiment the rear wall is executed preferably as one or more doors and there is a moveable closing device in the compartment at the rear for closing off a part of the rear from the floor upwards when the doors are open and a moving resistance device, through which the air flowing into the compartment encounters resistance, for covering a part of the rear from the roof downwards when the doors are open. The resistance device is preferably a perforated plastic covering. When the transport vehicle is being loaded and the uppermost floor is loaded first, the closing device can be used for the floors lying below. Because of this, the air drawn in flows through the uppermost floor. If the floors lying below were not closed off, all the air drawn in would be drawn in through these empty floors because the air encounters less resistance there. In that case, the uppermost floor where chickens are already situated would not be ventilated or would be insufficiently ventilated. The advantage of the resistance device, which will cover that part of the rear above the floor which is loaded, is that the air speed in the upper floors is not too high and sufficient air will be drawn in through the flood being loaded. Preferably the closing device comprises a plastic covering which can be rolled up and which extends over the entire width of the compartment.

The invention also relates to a method for ventilating a compartment of a transport vehicle, which compartment as seen in the direction of travel, has a front wall and a rear wall, as well as a roof, a floor and two side walls, in which method air is extracted from the compartment through openings in the front wall of the compartment. As to the method, the invention is characterized in that air is also extracted from the compartment through openings in the rear wall of the compartment, whereby the air is extracted alternately during a period through the openings in the front wall and a period through the openings in the rear wall.

An embodiment of the method is characterized in that the air extracted from the compartment is exhausted to outside the transport vehicle in a direction at least substantially parallel to the direction of travel of the transport vehicle. This is particularly advantageous with transport vehicles having a cab which is situated in front of and at a distance from the compartment.

A further embodiment of the method is characterized in that just after the compartment is filled with animals and the rear door or doors is/are closed first the air is exhausted through the openings in the rear wall during a longer period than during the alternately venting through the openings in the front and rear wall.

### BRIEF DESCRIPTION OF THE DRAWINGS

The invention will be elucidated more fully below on the basis of drawings in which an embodiment of the transport vehicle according to the invention is shown. In these drawings:

FIG. 1 is a side view of an embodiment of the transport vehicle according to the invention in which the compartment is shown in cross-section;

FIG. 2 is a view from above of a front part of the transport vehicle's compartment;

FIG. 3 is a front view of the compartment; and

FIG. 4 is a rear view of the compartment.

### DETAILED DESCRIPTION OF THE DRAWINGS

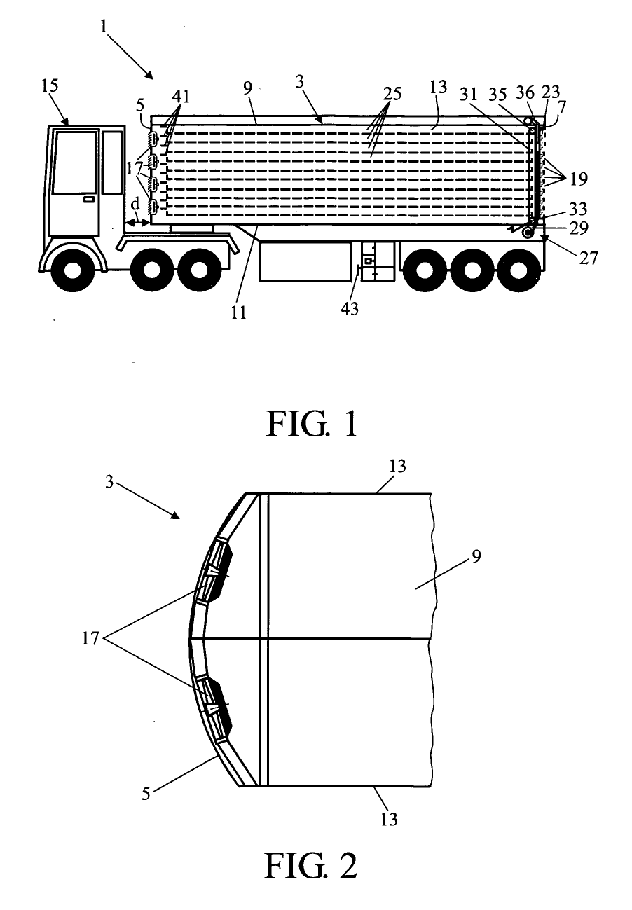

In FIG. 1 an embodiment of the transport vehicle 1 according to the invention is shown in a side view. The transport vehicle is suitable for transporting chickens and has a compartment 3 with a front wall 5, a rear wall 7, a roof 9, a floor 11 and two side walls 13. For the sake of clarity, the compartment is shown here in cross-section. The transport vehicle 1, furthermore, has a cab 15 situated in front of and at a distance d from the compartment 3. There are eight ventilating fans 17 in openings in the front wall 5 of the compartment 3, which are situated behind the cab 15 in openings in the front wall 5. Further there are six further ventilating fans 18 in openings in the rear wall 7 of the compartment 3. These six further ventilating fans 18 have the same overall venting capacity as four of the ventilating fans 17 in the front wall 5. The ventilating fans are set up in such a way that they extract air from the compartment 3 and blow it outside.

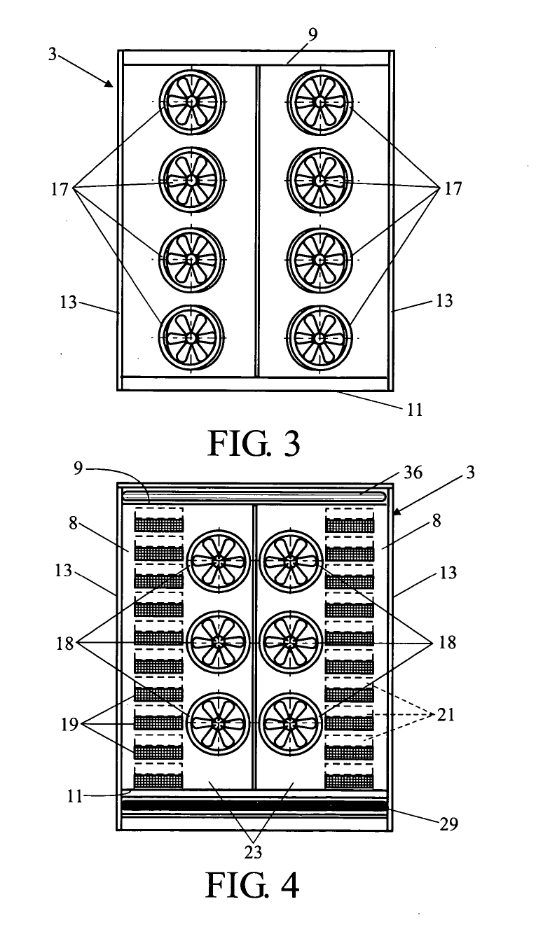

In FIGS. 2 and 3, the position of the ventilating fans 17 in the front wall 5 and in FIG. 4 the position of the further ventilating fans 18 in the rear wall 7 can be seen clearly.

The rear wall 7 of the compartment 3 is made up of two doors 8, see FIGS. 1 and 4. In the rear wall 7 there are a number of air vents 19 for letting fresh air in. The size of the air vents 19 can be adjusted by means of sliding devices 21 (see FIG. 4), which can be slid in front of the air vents 19. There is a sponge 23 made of plastic wire in front of the air vents 19 on the inner side of the rear wall 7. This sponge 23 is a resistance device through which the air flowing into the compartment encounters resistance. The roof 9, the floor 11 and the side walls 13 are closed.

There are a number of floors 25 in the compartment, see FIG. 1. In the compartment 3 at the rear there is a moveable closing device 27 for closing off a part of the rear from the floor 11 upwards. This closing device 27 comprises a plastic covering 29 that can be rolled up and which extends over the entire width of the compartment 3. One end of the plastic covering 29 is attached to cables 31 near the side walls 13 of the compartment 3, which are led round two wheels 33 and 35 at the top and bottom of the compartment 3. One of the wheels 33 can be driven in order to raise or lower the plastic covering 29.

In the compartment 3 at the rear there is further a moving resistance device 36, made of a perforated plastic covering, through which the air flowing into the compartment 3 encounters resistance, for covering a part of the rear from the roof 9 downwards when the doors 8 are open.

For regulating the ventilating fans 17, there are temperature sensors 41 on each floor 25 of the compartment 3 as well as a sensor for the outside temperature 43.

During circumstances when temperature is not low, for example above 5 degrees Celsius, the air is only exhausted by the ventilating fans 17 in the front wall 5 of the compartment 3. In that case the openings in the rear wall 7 wherein the further ventilating fans 18 are present are closed and the air is taken in through the adjustable air vents 19 in the rear wall 7.

During circumstances when temperature is low, for example below 5 degrees Celsius, the air is alternately, for example during periods of 3 minutes, exhausted through openings in the front and rear wall 5, 7 whereby the air is alternately taken in through openings in the opposite wall. The air vents in the front and rear walls 5, 7 are in that case formed by the openings in which the ventilating fans 17, 18 and the adjustable air vents 19 in the rear wall 7 are closed. Because of this the temperature in the compartment and especially in the rear of the compartment will be less low than in case air is only exhausted through openings in the front wall of the compartment 3.

During loading of the compartment in case the outside temperature is low only the ventilating fans 17 in the front wall 5 are operative. After the compartment is loaded the doors 8 are closed and during a time longer than 3 minutes only the further ventilating fans 18 in the rear wall 7 are operative to increase the temperature in the rear of the compartment 3.

Although in the above the invention is explained on the basis of the drawings, it should be noted that the invention is in no way limited to the embodiment shown in the drawings. The invention also extends to all embodiments deviating from the embodiment shown in the drawings within the context defined by the claims. Thus the ventilating fans can also be situated in the side walls 13 near the front of the compartment 3.

1. A transport vehicle for transporting animals, the transport vehicle comprising:
a compartment with, as viewed in the direction of travel, a front wall and a rear wall, as well as a roof, a floor and two side walls;
at least one ventilating fan, situated in or near an opening in the front wall, as well as at least one air vent in one of the compartment's walls, for taking in air, the ventilating fan is set up in such a way that it extracts air from the compartment, characterized in that the transport vehicle comprises at least one further ventilating fan, situated in or near an opening in the rear wall of the compartment.

2. The transport vehicle of claim 1, wherein the ventilating fan is operably positioned to exhaust the air to outside the transport vehicle in a direction at least substantially parallel to the direction of travel.

3. The transport vehicle of claim 2, further comprising a cab which, as viewed in the direction of travel, is situated in front of as well as at a distance from the compartment, and the ventilating fan is situated behind the cab.

4. The transport vehicle of claim 3, further comprising:
a number of floors in the compartment;
a number of additional ventilating fans which are distributed vertically in the front wall;
a number of additional further ventilating fans, which are distributed vertically in the rear wall; and
a number of additional air vents which are distributed vertically in the rear wall adjacent the further ventilating fans.

5. The transport vehicle of claim 4, wherein the rear wall is executed as one or more doors and that there is a movable closing device in the compartment at the rear for closing off a part of the rear from the floor upwards when the doors are open, and a moving resistance device, through which the air flowing into the compartment encounters resistance, for covering a part of the rear from the roof downwards when the doors are open.

6. The transport vehicle of claim 5, wherein the resistance device is a perforated plastic covering.

7. The transport vehicle of claim 5, wherein the closing device comprises a plastic covering that can be rolled up, which extends over the entire width of the compartment.

8. A method for ventilating a compartment of a transport vehicle, the method comprising the steps of:
providing the transport vehicle having the compartment, wherein the compartment, as viewed in the direction of travel, has a front wall and a rear wall, as well as a roof, a floor and two side walls; and
extracting air from the compartment through openings in the front wall of the compartment, characterized in that air is also extracted from the compartment through openings in the rear wall of the compartment, whereby the air is extracted alternately during a period through the openings in the front wall and a period through the openings in the rear wall.

9. The method of claim 8, wherein the air extracted from the compartment is exhausted to outside the transport vehicle in a direction at least substantially parallel to the direction of travel of the transport vehicle.

10. The method according to claim 9, wherein just after the compartment is filled with animals and the rear door or doors is/are closed, first the air is exhausted through the openings in the rear wall during a longer period than during the alternately venting through the openings in the front and rear wall.
